(19) United States
(12) Patent Application Publication
(10) Pub. No.: US 2016/0155433 A1
(43) Pub. Date: Jun. 2, 2016

(54) ULTRASOUND APPARATUS AND METHOD

(71) Applicant: 168 Ultrasound Pte Ltd, Singapore (SG)

(72) Inventors: Cory Siverson, Bangkok (TH); Edward Laing, Singapore (SG)

(21) Appl. No.: 14/952,209

(22) Filed: Nov. 25, 2015

(30) Foreign Application Priority Data
Nov. 28, 2014 (GB) 1421175.9

(51) Int. Cl. G10K 11/02; B32B 27/08; B32B 38/00; B32B 27/32; B32B 25/20; B32B 37/14; B32B 7/02; B32B 27/30

(52) U.S. Cl. CPC G10K 11/02; B32B 7/02; B32B 27/08; B32B 27/304; B32B 27/32; B32B 27/302; B32B 25/20; B32B 37/144; B32B 38/0012; B32B 2307/10; B32B 2264/105; B32B 2264/107; B32B 2264/108; B32B 2264/10; B32B 2264/102; B32B 2323/10; B32B 2325/00; B32B 2383/00; B32B 2327/12

(57) ABSTRACT

A matching layer is described for facilitating the transmission of ultrasound energy between an ultrasound source and a target, the matching layer having an acoustic impedance that decreases across the matching layer. The matching layer comprises at least 10 adjacent composites, each composite comprising a carrier material and each composite having an acoustic impedance lower than that of the adjacent composite. Methods of manufacturing the matching layer, and ultrasound apparatus used in conjunction with the matching layer are also described.

The present invention relates to an apparatus for use in conjunction with an ultrasound system, a method of manufacturing the apparatus and a method of using such an apparatus. In particular, the present invention relates to an acoustic impedance matching layer for an ultrasound apparatus, a method of manufacturing the matching layer and a method of using it as part of an ultrasound apparatus.

Ultrasound scanning can he used for medical imaging. In particular, it can be used for visualising internal body structures such as muscles, tendons, joints and internal organs. The ultrasound images, or sonograms, are created by sending ultrasound pulses into a tissue using an ultrasound transducer, or probe. These pulses are reflected off parts of the tissue to form echoes, and the probe is than used to detect these echoes which are subsequently processed to create an image of the target. Ultrasound scanning is particularly useful as it is non-invasive so can be used for scanning a baby during pregnancy.

Ultrasound is also widely used for industrial applications, for example for monitoring the thickness of metals during manufacture, for detecting flaws in materials, for measuring the flow of a fluid using ultrasonic flow meters and for tracking and/or identifying the location of objects in real time, particularly for underwater range finding.

Like other sound waves, the speed of transmission of ultrasound waves, or energy, varies depending on the material through which the wave is travelling. Factors such as the density and compressibility of the material, which relate to the material's acoustic impedance, impact the speed at which sound travels through the material. As the sound wave passes from a first material of one impedance into a second material of another impedance, some of the sound energy is reflected at the boundary.

To reduce the reflection of ultrasound waves at the boundary between the transducer and the material being scanned, or target, a matching layer is used that has an acoustic impedance between that of the transducer and that of the material to be scanned. Often, the impedance of the matching layer is a simple geometric mean between the impedance of the transducer and the impedance of the target. In providing a material with an intermediate impedance, the matching layer enables the sound wave to “slow down” more slowly as it approaches the target, rather than presenting it with just one sudden and very significant change in impedance at the surface of the target. Hence, the matching layer reduces the amount of ultrasound energy reflected from the boundary between the transducer and the target material and therefore increases the amount of energy in the signal that passes into the target material.

However, even using a matching layer, the ultrasound energy still sees a significant change in impedance at each of the boundaries between the transducer and the matching layer and between the matching layer and the target.

Further, as described in more detail below, high frequency ultrasound can be used to increase the resolution of an ultrasound image. However, since attenuation of high-frequency ultrasound is higher than ultrasound of lower frequency, it can be necessary to operate the ultrasound apparatus at high power in order to transfer sufficient energy into the target. The use of high power can cause problems if the ultrasound hits the resonant frequency of the material it is passing through. The combination of an increased power and the ultrasound hitting a resonant frequency of the particles in the matching layer, causes a surge of energy through the layer and into the target, which can be damaging to the target.

Thus, there is a need for an improved matching layer, and method of manufacture thereof, and in particular a matching layer that is advantageous for use with higher frequency ultrasound. It is an object of embodiments of the present invention to seek to address all or some of the above problems.

### STATEMENTS OF INVENTION

Aspects of the invention are set out in the independent claims and preferred features are set out in the dependent claim. Features of one aspect may be provided in conjunction with other aspects described herein.

In a first aspect, there is provided a matching layer for facilitating the transmission of ultrasound energy between an ultrasound source and a target, the matching layer having an acoustic impedance that decreases across the matching layer, wherein the matching layer comprises at least 10 adjacent composites, each composite comprising a carrier material and each composite having an acoustic impedance lower than that of the adjacent composite.

Providing a matching layer between an ultrasound source and a target that has a decreasing impedance across its thickness (in the direction of source to target) eases the transition of the ultrasound wave from the source and into the target material, reducing reflection and refraction of energy at impedance boundaries between the source and target. This increases the proportion of ultrasound energy produced by the transducer that enters into the target, particularly for high frequency ultrasound.

This means that high frequency ultrasound becomes a viable imaging option, which means that images can be obtained at higher resolution. In particular, a lower energy of high frequency ultrasound can produce the same image quality, which reduces the problem of hitting the resonant frequency of the matching layer and/or target material (for example the tissue to be scanned); it is no longer necessary to use such a high power in generating the ultrasound waves since there is reduced attenuation of the high frequency ultrasound as it passes through the matching layer. Therefore, there are fewer problems with resonant frequencies of waves causing energy surges through the material and into the target. This may also reduce costs as less power need be supplied.

In particular, providing a matching layer comprising at least 10 composites of differing acoustic impedance means that the difference in acoustic impedance at each boundary is lower than it would he with fewer composites or sub-layers. Further, the use of a carrier to form each composite means that each composite can be manufactured to react physically in very similar ways, both during manufacture and with regard to its interaction with ultrasound waves passing through it.

As described in more detail below, the carrier material may be the same for each composite layer, but it will at least be a very similar material for each of the composites, for example different layers may comprise a different mixture of a common set of carriers.

In a preferred embodiment, a plurality of the composites further comprise a dopant, preferably each composite comprises a dopant. In some embodiments, each composite comprises the same dopant material. The dopant material is used to alter the acoustic impedance of the carrier such that each composite is manufactured with a predefined acoustic impedance for incorporation into the matching layer.

Preferably, each composite comprises the same carrier material, in a particular embodiment, a polymeric carrier material. Many polymeric carrier materials have low attenuation and low impedance, which are helpful properties for the carrier material used in the present matching layer.

Preferably, the dopant is mixed with the carrier to form substantially homogeneous composites. Each composite therefore presents substantially homogeneous properties to the ultrasound wave passing through it, which therefore does not interact in a different way with the carrier and the dopant. Preferably, the dopant and carrier are mixed such that the appear homogeneous at a scale of λ/10.

Preferably, the proportion of dopant to carrier in each of the composites varies between composites to vary the acoustic impedance of each composite. That is, the more dopant in a composite, the higher the acoustic impedance of that composite.

In a preferred embodiment, the acoustic impedance of the dopant is at least three, preferably at least five times that of the carrier. In some embodiments, the dopant may have an acoustic impedance ten or twenty times that of the carrier. Using a dopant with a high acoustic impedance enables composites with higher acoustic impedance to be created with less of the dopant material, and therefore with more consistent physical properties across the impedance matching layer.

Preferably, the matching layer further comprises a primer for increasing the surface energy of the carrier. As described in more detail below, increasing the surface energy of the carrier can promote the formation of bonds between molecules of the carrier and other components in the composite or with carrier material in other composites of the matching layer.

Preferably, the matching layer further comprises a primer for promoting cross-linking or the formation of bonds between the carrier and the dopant.

In a preferred embodiment, the primer is disposed between the carrier and the dopant. Hence the primer can enable cross-linking or bonding between the carrier and the dopant, as described in more detail below.

Optionally, the matching layer comprises at least 20 layers, preferably at least 50 layers, further preferably at least 100 layers. Matching layers may even be manufactured with 500, 1000 or several thousand composites. The more composites of different acoustic impedance there are in the matching layer, the smaller the difference in acoustic impedance between each layer and the more gradual the change in acoustic impedance appears to be to the ultrasound energy, causing less dissipation of the energy before it reaches the target.

In some embodiments, the thickness of the matching layer is less than 5 mm, preferably less than 1 mm, further preferably less than 0.6 mm. An impedance matching layer for low-frequency ultrasound (of around 1-5 MHz) would typically be around 1 mm in thickness.

In some embodiments, the thickness of the matching layer is less than 0.1 mm, preferably less than 0.05 mm, further preferably less than 0.01 mm. An impedance matching layer for high-frequency ultrasound (of greater than 10 MHz) would typically be around 10 microns in thickness.

Preferably, the average difference in acoustic impedance between adjacent composites is one tenth of the difference in acoustic impedance between a first and final composite in the matching layer.

In a highly preferred embodiment, the acoustic impedance decreases substantially linearly across the matching layer. Hence the ultrasound energy sees a gradual and consistent decrease in impedance, rather than any abrupt change.

Preferably, the composites are superimposed directly without an adhesive layer, since it can be advantageous to avoid introducing a different material, which will have a different acoustic impedance.

Preferably, the malleability of each composite is substantially constant so that each composite reacts in the same way during the manufacturing process and the matching layer has substantially constant physical properties throughout its thickness.

Optionally, the ultrasound source has an acoustic impedance and wherein the composite for placement adjacent to the ultrasound source has an acoustic impedance that substantially matches that of the ultrasound source. This can enable the ultrasound energy to pass out of the source and into the matching layer with minimum losses.

Optionally, the target has an acoustic impedance and wherein the composite for placement adjacent to the target has an acoustic impedance that substantially matches that of the target. This can enable the ultrasound energy to pass out of the matching layer and into the target with minimum losses.

Preferably, substantially matches comprises within 10%, preferably within 5%, further preferably within 2% of the acoustic impedance of the ultrasound source or target.

Preferably, the thickness of each composite in the matching layer is substantially the same.

Preferably, the thickness of each composite in the matching layer is less than 10 microns, preferably around 2 microns.

In a highly preferred embodiment, the carrier comprises a curable polymer. In particular, the carrier may comprise one of, a mixture of, or copolymers of, the following: rubber, epoxy, polystyrene, polyurethane, polyethylene, polypropylene, polybutylene, polyvinyl chloride, polybiphenyl chloride, polymethylmethacrylate and polycarbonate.

In one embodiment, the carrier comprises a chemical cure polymer, such as an epoxy or a silicone.

Alternatively, the carrier comprises a thermoset polymer, preferably wherein the polymer comprises at least one of: a polypropylene, acrylonitrile butadiene styrene (ABS), polyethylene, Bakelite, a HVAC silicone and/or a high-consistency rubber.

In a further embodiment, the polymer comprises polyvinylidene fluoride (PVDF).

In a particular embodiment, the polymer comprises silicone.

In a highly preferred embodiment, the dopant has a high acoustic impedance.

In particular, the dopant may comprises a metal or a ceramic. Suitable materials include zirconium, gold, platinum, nickel, aluminium, titanium, zinc, lead, tin, iron, cobalt, copper, manganese, chromium, tungsten, silver, silicon, magnesium, glass, cement and mixtures and alloys thereof.

In one embodiment, the dopant comprises carbon, which may be formed into nanoparticles.

Preferably, the dopant comprises a metallic or transition metal carbide or oxide, a metal sulphide or a metal nitride.

A matching layer according to any preceding claim wherein the dopant comprises at least one of: aluminium oxide, zirconium carbide, tungsten carbide, yttrium oxide and zirconium oxide.

Optionally, the dopant comprises a metallic or transition metal carbide, oxide, sulphide or nitride. Preferably, the dopant comprises at least one of: aluminium oxide, zirconium carbide, tungsten carbide and zirconium oxide. In one embodiment, the dopant may comprise a combination of materials, in particular a combination of those listed above.

In a preferred embodiment, the acoustic impedance of the dopant is at least 12 MRayls, preferably at least 20 MRayls, further preferably at least 50 MRayls.

In a preferred embodiment, the acoustic impedance of the carrier is less than 10 MRayls, preferably less than 5 MRayls, further preferably less than 2 MRayls.

Preferably, the acoustic impedance of the carrier is within 20% of the acoustic impedance of human or animal tissue.

In a particularly preferred embodiment, the dopant and the carrier each has a low acoustic attenuation.

According to a further aspect, there is provided a method of manufacturing a material to form a composite for an ultrasound matching layer, the method comprising:

providing a starter for the composite, the starter comprising a carrier material;

providing a plurality of pellets of the carrier material;

providing particles of a dopant material, wherein the particles of the dopant material are smaller than the pellets of the carrier material;

adding to the starter a predetermined weight of the dopant material to form a composite having a selected acoustic impedance;

adding to the starter a complementary weight of pellets of the carrier material such that the total weight of dopant and carrier added to the starter remains the same regardless of the selected acoustic impedance.

The use of pellets, which may take many shapes, but are small balls or particles of the carrier material, and particles of the dopant, and the mixing of a consistent weight of these pellets and particles into the composite starter can ensure that each composite has consistent physical properties, in particular its malleability, ductility or viscosity. For example, as described in more detail below, a first composite may comprise 100 pellets of carrier, a second composite may comprise 99 pellets of carrier and the equivalent of 1 pellet by weight of dopant, a third composite may comprise 98 pellets of carrier and the equivalent of 2 pellets by weight of dopant. The final composite may comprise the equivalent of 100 pellets by weight of dopant. The numbers provided above are indicative of the ratios use in each composite but, as the skilled person will appreciate, the actual number of pellets (or their particulate equivalent of dopant) added to each composite is likely to be a number of orders of magnitude higher.

The pellets and particles are preferably measured by weight and the relative proportions of carrier to dopant can be determined by weight.

Preferably, wherein the pellets of the carrier material comprise cured carrier material. Hence the carrier pellets may comprise exactly the same material as the carrier starter material, but in a cured form.

Preferably, providing the plurality of pellets of the carrier material comprises extracting a portion of the carrier material from the starter, curing the portion of the carrier material and forming the cured carrier material into pellets. Providing the plurality of pellets of the carrier material may comprise grinding or sputtering the carrier material to form the pellets.

The pellets of the carrier material may have a diameter of less than 10 microns, preferably around 2 microns.

Preferably, the particles of the dopant material are 100 times smaller, preferably 1000 times smaller than the pellets of the carrier material.

In particular, the particles of the dopant material may comprise a powder, preferably wherein the diameter of the particles in the powder is less than 100 nm.

In one embodiment, providing particles of a dopant material comprises grinding the dopant material to form a powder. In an alternative embodiment, providing particles of a dopant material comprises growing nanoparticles of the dopant material.

Preferably, the method further comprising coating the particles of the dopant material with a primer. In particular, the dopant may be coated with a primer prior to adding the dopant to the carrier starter. A suitable primer would be a primer that provides a high-resolution thorough coating to all parts of the carrier polymer. In particular, a surface adhesion promoter would be suitable for use, for example with a silicone carrier.

Preferably, the starter comprises at least 40% by weight of the composite.

Preferably, the dopant particles and carrier pellets comprise at least 40% of the composite.

In a particular embodiment, the composite may comprise around 50% by weight of the carrier starter and around 50% by weight of the dopant particles and carrier pellets.

There is also described herein a method of manufacturing a composite comprising providing particles of a dopant material, coating the dopant material with a primer and mixing the coated dopant material with a carrier material, wherein the primer promotes cross-linking between the dopant material and the carrier material. Preferably, the carrier material comprises a low-surface energy carrier material and the primer acts to increase the surface energy of the carrier material. The primer may also promote the spreading and coverage of the dopant material within the carrier material or over the surfaces of the carrier material when the dopant is mixed in with the carrier material. In some embodiments, the method further includes applying energy to the carrier/dopant/primer mixture in order to promote cross-linking. The energy may include electromagnetic or sound energy. In some embodiments, a reagent such as ozone may be provided in order to enable further cross-linking. This method may also be provided in conjunction with the other manufacturing methods described herein.

According to a further aspect, there is provided a method of manufacturing a material to form a composite for an ultrasound matching layer, the composite comprising a carrier material having a first acoustic impedance and a dopant having a second acoustic impedance, the method comprising the steps of:

mixing the dopant with the carrier in a predetermined ratio to produce a material with a selected acoustic impedance;

calendering the material;

folding or coiling the calendered material; and

repeating the steps of calendaring and folding or coiling at least 10 times, preferably at least 100 times.

The composite manufacturing method provides a high level of mixing of the carrier and dopant materials to produce a substantially homogeneous composite with a high number of cross-links between dopant and carrier. The method also removes air bubbles from the mixture, or reduces them in size to less than λ/10 of the ultrasound waves, which renders them substantially invisible to the ultrasound waves passing through them.

In a particularly preferred embodiment, the material is rolled such that the edge portions of the material are moved into the centre for the next calendering process. This ensures that the whole of the composite is well mixed.

Preferably, the dopant is mixed with the carrier in accordance with the method of the preceding aspect.

Optionally, the method further comprises adding a catalyst to cure the material after the repeated steps of calendering and folding or coding. Once the catalyst has been added, the composite may be further calendered and folded/coiled in order to mix the catalyst into the composite. Adding the catalyst at a later stage delays the “cure” of the material, keeping it more flexible and pliable until it is needed.

According to a further aspect, there is provided a method of manufacturing an impedance matching layer for an ultrasound apparatus, the method comprising:

providing a plurality of composites, each composite having a different acoustic impedance;

arranging the composites in a stack in decreasing order of acoustic impedance;

calendering the stack of composites to reduce the thickness of the stack.

The method can produce an impedance matching layer with a high number of composites of differing acoustic impedance. Hence, the impedance matching layer can provide a gradual, preferably linear, decrease in acoustic impedance for an ultrasound wave passing from the source to the target.

The method enables the accurate manufacture of a matching layer with multiple layers and is particularly useful where the matching layer includes a large number of layers, for instance 100 or 1000. For example, in a matching layer containing 1000 layers, the step in acoustic impedance across each boundary only needs to be approximately 28.5 kRayl (approximately ((30−1.5)/1000) or see equation (1) below) which means that the boundaries between layers are effectively transparent to the ultrasound wave. Thus, the ultrasound wave effectively experiences a material of gradually decreasing acoustic impedance, and never experiences a boundary from which it can reflect. This means that a much greater proportion of the energy of the ultrasound wave reaches the material to be scanned. Thus, high frequency ultrasound can be used with such a matching layer, to provide high resolution images without requiring the need for high power.

In one embodiment, the thickness of the stack is reduced to less than 1 mm, preferably less than 0.1 mm, further preferably less than 0.01 mm. The thickness of the matching layer may depend on the intended frequency of the ultrasound wave that will be passing through the matching layer.

In a preferred embodiment, the method comprises providing at least 10 composites, preferably at least 20 composites, further preferably at least 50 composites. The larger the number of composites, the more gradual the change in acoustic impedance between composites in the matching layer.

Preferably, the method further comprises calendering each composite prior to arranging the composite in the stack. This can be done to remove air bubbles in each composite and to ensure that each composite has a consistent thickness before the whole stack is processed.

In one embodiment, the carrier comprises a polymer, preferably a curable polymer which may be a chemical cure polymer, preferably an epoxy or a silicone or a thermoset polymer, preferably at least one of: a polypropylene, acrylonitrile butadiene styrene (ABS), polyethylene, Bakelite, a HVAC silicone and/or a high-consistency rubber. In one embodiment, the polymer comprises polyvinylidene fluoride (PVDF). In another embodiment, the polymer comprises silicone.

In one embodiment, the dopant comprises a metallic or transition metal carbide or oxide. Preferably, the dopant comprises at least one of: aluminium oxide, zirconium carbide, tungsten carbide and zirconium oxide.

Preferably, the acoustic impedance of the dopant is at least 12 MRayls, preferably at least 20 MRayls, further preferably at least 50 MRayls. Preferably, the acoustic impedance of the carrier is less than 10 MRayls, preferably less than 5 MRayls, further preferably less than 2 MRayls. Preferably, the acoustic impedance of the carrier is within 20% of the acoustic impedance of human or animal tissue. In a preferred embodiment, the dopant and the carrier each has a low acoustic attenuation.

According to a further aspect, there is provided a matching layer for facilitating the transmission of ultrasound energy between an ultrasound source and a target, the matching layer having an acoustic impedance that decreases across the matching layer, wherein the matching layer comprises at least 25 composites each composite having a different acoustic impedance, and wherein the average difference in acoustic impedance between adjacent composites is at least one twenty-fifth of the difference in acoustic impedance between the first and last composite in the matching layer.

Providing a matching layer comprising a high number of composites, each having a small difference in acoustic impedance, means that the acoustic impedance presented to the ultrasound wave changes gradually through the impedance matching layer and there are fewer reflections and refractions of energy as the wave passes through the matching layer, which means that a higher proportion of the energy in the wave passes through the matching layer.

Preferred features of the first aspect described herein may be applied to the present aspect.

According to a further aspect, there is provided a matching layer for facilitating the transmission of ultrasound energy between an ultrasound source and a target, the matching layer having an acoustic impedance that decreases across the matching layer, wherein the matching layer comprises a plurality of composites each composite having a different acoustic impedance, wherein the difference in acoustic impedance between adjacent composites is less than 0.3 MRayls, preferably less than 0.1 MRayls.

A gradual change in impedance between composites presents fewer boundaries to the ultrasound wave. Preferably, the boundaries are invisible to the ultrasound wave, enabling more of the energy to pass through the impedance matching layer.

Preferred features of the first aspect described herein may be applied to the present aspect.

A matching layer for facilitating the transmission of ultrasound energy between an ultrasound source and a target, the matching layer having an acoustic impedance that decreases across the matching layer, wherein the matching layer comprises a plurality of composites each composite having a different acoustic impedance and wherein at least 50%, preferably at least 75%, of the power of the ultrasound wave that enters the matching layer is transmitted through the matching layer.

In addition to a high level of energy transmission through the layer, the ultrasound wave also retains a high quality as it is transmitted through, and reflected back through the matching layer. This is due to the low level of refraction and scattering of energy within the matching layer.

Preferred features of the first aspect described herein may be applied to the present aspect.

According to a further aspect, there is provided an ultrasound imaging apparatus comprising an ultrasound source, a power source for applying electrical power to the ultrasound source and a matching layer as described above or as manufactured by a method described above.

Preferably, the acoustic impedance of the first composite in the matching layer is substantially the same as the acoustic impedance of the ultrasound source. This can enable a high proportion of the energy from the source to pass into the matching layer.

According to a further aspect, there is provided a method of obtaining an ultrasound image of a target using an ultrasound source, the method comprising:
applying an impedance matching layer as described above between the target and the ultrasound source;
applying electrical energy to the ultrasound source to generate ultrasound energy;
transmitting the ultrasound energy through the impedance matching layer to the target;
receiving from the target reflected ultrasound energy;
analysing the reflected ultrasound energy; and
producing an image of the target based in the reflected ultrasound energy.

### BRIEF DESCRIPTION OF THE DRAWINGS

Embodiments of the present invention will now be described, by way of example only, with reference to the accompanying drawings, in which:

FIG. 1 shows an annotated sine wave, representative of how ultrasound energy travels through a medium;

FIG. 2 shows a simplified cross section of a typical ultrasound probe in accordance with an embodiment of the present invention;

FIG. 3 shows a schematic diagram of a matching layer in accordance with an embodiment of the present invention, the total number of layers shown being non-limiting and not necessarily all of the layers being shown;

FIG. 4 shows a schematic diagram of mixers containing portions of material suitable for use in making different composites of a matching layer in accordance with an embodiment of the present invention; and

FIG. 5 shows a schematic diagram through a part of a typical calender for use in rolling out the individual composites, and the pile of composites with differing acoustic impedances when ready to form a matching layer, in accordance with an embodiment of the present invention.

Typically, ultrasound sources have a housing containing a backing block, electrodes and a transducer typically in the form of a piezoelectric crystal. Power is supplied to the electrodes which in turn apply a voltage across the piezoelectric crystal. This causes the piezoelectric crystal to vibrate at high speed, which produces pulses of ultrasound energy. Thus the voltage applied across the crystal determines the frequency of the ultrasound generated. The backing block is layered on the back of the piezoelectric crystal to absorb backwardly directed ultrasound pulses and to attenuate stray ultrasound signals from the housing.

As mentioned above, ultrasound reflects at boundaries where there is a change in acoustic impedance, the proportion of energy reflected calculated approximately according to equation (1) where Z₁ is the acoustic impedance of the first material and Z₂ is the acoustic impedance of the second material:

$$Reflection coefficient , R = \frac{{Z}_{2} - {Z}_{1}}{{Z}_{2} + {Z}_{1}} \qquad Equation ( 1 )$$

Thus to minimise the loss of energy via reflection, in making an impedance matching layer with multiple strata, the difference in acoustic impedance between adjacent strata should be minimised as much as possible.

Frequencies used in medical ultrasound imaging are in the range of approximately 1 MHz to 15 MHz. However, the matching layer described herein would enable the use of ultrasound at higher frequencies, up to 500 MHz, giving a much greater image resolution. Typically, a piezoelectric transducer has an acoustic impedance of approximately 30-35 MRayls, whereas human tissue has an acoustic impedance of approximately 1.5 MRayls. At low frequencies (approximately 1-5 MHz), a relatively high proportion of energy can be transferred into the target, although a matching layer can still be useful. At these low frequencies, a stratified matching layer can be used, which typically includes approximately 3-5 strata, each with a different acoustic impedance and subsequent strata reducing in acoustic impedance away from the piezoelectric crystal. For example, the stratum closest to the transducer may have an impedance matching that of the transducer, at around 30 MRayls and subsequent strata can be provided with impedances of 20, 10 and 1.5 MRayls, the final stratum having an impedance matching that of the target, in this case the tissue. Other appropriate acoustic impedances can be used. This allows for the ultrasound waves to pass through a series of layers providing a more gradual decrease in acoustic impedance as it passes from the crystal to the material to be scanned.

At higher frequencies, providing an impedance matching layer becomes very difficult since attenuation of the ultrasound signal as it passes into the tissue is high. At high frequency, the particles in the material are being forced to vibrate so quickly that they cannot reach the full amplitude of their vibration in order to efficiently transfer energy to adjacent particles and thus through the strata and matching layer. Further to this, given the high speed of the vibration, it takes the particles longer to slow down and stop vibrating, resulting in lost energy. Therefore, the only way to get sufficient energy into the material to view the internal structure is to use high power which can be costly and potentially dangerous. However, higher frequency transducers provide better image resolution; the resolution of the image is proportional to the wavelength (λ) of the ultrasound, on high frequency ultrasound therefore enables viewing of objects in high resolution. It is therefore desirable to use high frequency transducers.

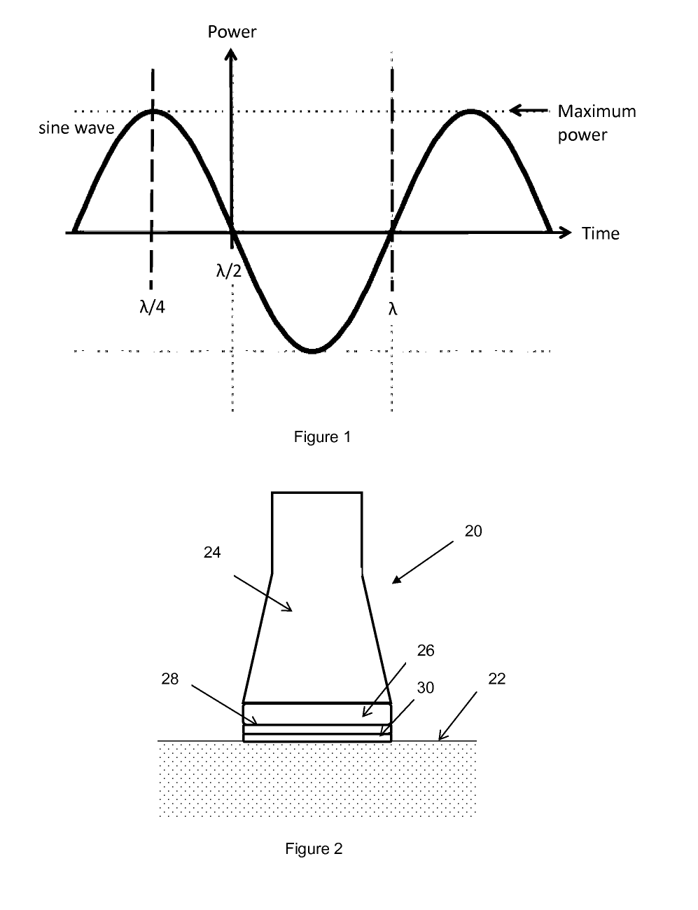

With reference to FIG. 1, ultrasound waves travel in the form of a sine wave. Therefore, to get the maximum power through a boundary between materials of different acoustic impedance, it is best if the sound wave hits the boundary one quarter of the way through its sine cycle i.e. at π/2 or λ/4 where it is at the peak of the sine curve and therefore at its maximum energy. If the wave is at its maximum energy at the boundary, it is more likely that more energy will pass through. Thus, in making a matching layer of multiple internal stratum, of different impedance between the transducer and the target, the boundaries of the layers within the matching layer should occur at a distance equal to λ/4 of the wave i.e. the thickness of each stratum should be an odd integer multiple of λ/4 i.e. λ14, 3λ/4, 5λ/4, 7λ/4 etc., the optimal thickness of each stratum being λ/4 to avoid unnecessary attenuation in the matching layer. At low frequencies, this is feasible as the layers only need to be about 1 mm thick. However, at high frequencies where wavelengths are on the scale of 1 μm, it is very difficult to manufacture a matching layer with internal layers that are accurate and consistent enough to fulfil this criterion. Furthermore, small variations or errors in thickness can compound and add up to a large mismatch with the wave energy in the boundaries of the final layers. This requirement to match boundaries within the impedance matching layer significantly limits the number of layers that can be provided within the impedance matching layer.

Thus, in making a matching layer according to an embodiment of the present invention, it is important to consider the above mentioned factors, in particular of minimising the difference in acoustic impedance between adjacent internal layers, having the total thickness of the matching layer equal an odd integer multiple of λ/4 and providing a matching layer that is suitable for use with high frequency ultrasound.

Referring to FIG. 2 according to an embodiment of the present invention, there is an ultrasound apparatus 20 for imaging the internal structure of a tissue 22. The apparatus, or probe, generates high frequency ultrasound for use in producing high resolution images. The apparatus comprises a housing 24 with power supply leads extending into the housing and around a backing layer 26 within the housing, towards two electrodes to which the leads connect. The electrodes sit on either side of a piezoelectric crystal 28 to apply a voltage across the crystal. The piezoelectric crystal borders a matching layer 30 and the other side of this matching layer borders the target material to be scanned, in this case a part of the body. The embodiment below is described for use in scanning tissue forming a part of the body, but the skilled person would immediately appreciate that the principles described herein could equally be applied to industrial applications.

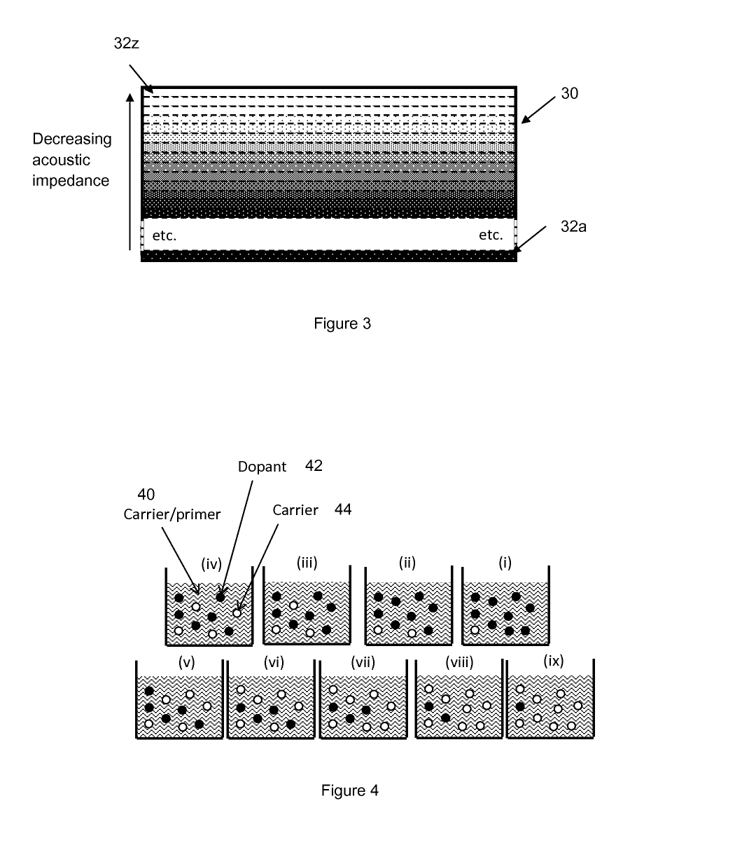

Referring to FIG. 3, the matching layer 30 of the ultrasound apparatus comprises a number of composites forming strata 32 or sublayers within the matching layer, typically 50, 100 or more, each with a different acoustic impedance. The first composite 32a lies adjacent to the piezoelectric crystal and has an acoustic impedance which substantially matches that of the crystal. The last composite 32n lies adjacent to the tissue to be scanned and has an acoustic impedance which substantially matches that of the tissue. This ensures that the first and last boundaries are substantially invisible to the ultrasound wave. The acoustic impedance gradually decreases between subsequent composites across the matching layer, from the first composite to the last composite, with the difference in acoustic impedance between adjacent composites being so small that all of the boundaries between the composites are invisible to the ultrasound wave. The ultrasound wave effectively experiences a continuous material with a substantially linear acoustic impedance gradient. Therefore, since the ultrasound wave never experiences a boundary, a large and useful proportion of the energy of the ultrasound wave passes through the matching layer and into the tissue in order to be used in the generation of images. This is also the case for the echoes, which also do not experience a boundary within the matching layer as they pass back from the tissue, through the matching layer and into the piezoelectric crystal.

Once the difference in acoustic impedance between the crystal and the tissue is calculated, and the number of composites to be used within the matching layer is decided on, the step in acoustic impedance, ΔZ, between adjacent layers can be calculated according to equation (2).

$$ΔZ = \frac{\begin{matrix}Acoustic impedance of crystal - \\ acoustic impedance of tissue\end{matrix}}{( Number of strata - 1 )} \qquad Equation ( 2 )$$

Alternatively, if a value for the desired step in acoustic impedance is decided on, and the acoustic impedance of the crystal and tissue are known, equation (2) can be re-arranged to calculate the number of composites required for a certain matching layer.

Each composite within the matching layer comprises a carrier material. The carrier material comprises a polymer having a low attenuation and a low acoustic impedance often substantially matching that of the tissue to be scanned. In particular, silicone, and more particularly a silicone rubber may be used as a carrier material. Silicone is itself a polymer and silicone rubbers are often one or two part polymers, which may contain fillers to improve properties and/or to reduce cost.

The polymer may comprise a chemical cure polymer such as an epoxy, in particular a urethane epoxy, or it may be a two part silicone, meaning that the reactive ingredients are segregated to prevent premature initiation of the curing process and heat is applied to initiate and/or speed up the process.

Alternatively, the polymer may be a thermoset such as a polypropylene, acrylonitrile butadiene styrene (ABS), polyethylene, Bakelite, a HVAC silicone and/or a high-consistency rubber. Alternatively, the polymer may comprise polyvinylidene fluoride (PVDF). In addition to having a low attenuation and low acoustic impedance, PVDF has been observed as having a piezoelectric effect approximately ten times that of other polymers. This may be advantageous since the piezoelectric crystal of the ultrasound probe also has piezoelectric properties so the matching layer having similar properties can be used to enhance the effects of the crystal. Furthermore. PVDF is unreactive on has a high resistance to chemicals.

The polymer chain is loaded with a dopant, the dopant also having a low attenuation, but having a higher acoustic impedance, either between that of the tissue and crystal, or greater than that of the crystal. Often the dopant will also have a higher density than that of the carrier i.e. a density loading material. Therefore, the result of adding the dopant is to increase the acoustic impedance of the resultant material.

Silicone rubber typically has an acoustic impedance of around 1.5 MRayls so, without doping, it substantially matches the acoustic impedance of the tissue. Thus, from the side closest to the material to be scanned the carrier can be doped with an increasing proportion of the dopant to increase the acoustic impedance across the matching layer and alter its physical properties until at the surface of the piezoelectric crystal, the resultant acoustic impedance of the matching layer is approximately 30-35 MRayls i.e. that of the crystal. As far as the ultrasound energy is concerned, this eliminates a first and last boundary at either side of the matching layer and provides a homogeneous material with a gradually increasing gradient of acoustic impedance.

Typical dopants, or density loading materials, include metallic and transition metal carbides and oxides, and in particular zirconium carbide, aluminium oxide or a combination thereof. Alternatively, tungsten carbide and/or zirconium oxide can be used alone or in combination. Many other materials could be used as a dopant, including combinations of different materials, as long as use of the material, or materials, increases the acoustic impedance of a layer formed from the resultant doped polymer chain, as opposed to the pure polymer chain.

Aluminium oxide is particularly good for this purpose since it has low acoustic attenuation and an acoustic impedance of around 15 MRayls. However, materials with a higher acoustic impedance are also advantageous since a smaller amount of the dopant can be used and the acoustic impedance of each composite can be tempered by that of the silicone rubber. Tungsten carbide is also, therefore, particularly good for this purpose since it has a high acoustic impedance of around 120 MRayls. These materials are not isotropic so there are also effects on the acoustic impedance within each composite from the crystal structure and directionality thereof.

The matching layer needs to act as a homogeneous material so that the ultrasound wave sees the layer as homogeneous in cross-section. In particular, the particles in the matching layer need to be invisible to the wavefront so that the ultrasound waves do not scatter off the particles. Visibility of the particles depends on the particle size relative to the wavelength of the ultrasound, so the particle size required for the matching layer depends on the frequency of ultrasound being used. Where the particle size is much smaller than the wavelength of the ultrasound, the particle generally does not scatter the ultrasound significantly. Thus to avoid scattering, the diameter of particles in the matching layer, of both the carrier and dopant, should have an upper limit of approximately λ/10, and will preferably be much smaller than this. Waves will then generally pass freely through the matching layer, with minimal obstruction and attenuation.

In order to make the matching layer, composites of differing acoustic impedances are first manufactured. To do this, the carrier medium is doped with differing levels of the dopant material to provide each composite with a different acoustic impedance.

Each composite is first manufactured as a portion of doped carrier material. To manufacture each portion of doped carrier, a carrier material such as a silicone rubber, having a particle size of approximately 300-500 nm, is put into a mixer. The carrier material in the mixture has not been cured, so is in a pre-catalysed form and may be considered to be the “glue” in the mixture

Some of the carrier material is extracted, or retained outside the mixer. The extracted carrier material is cured, in particular by adding a catalyst to the material and is formed into beads or pellets using a technique such as sputtering or airborne vulcanization, or by grinding the cured material into pellets. Hence the pellets are simply a cured form of the carrier “glue”.

Preferably, each bead or pellet of the cured carrier material has a diameter of less than λ/10 so that they are invisible to an ultrasound wave.

The dopant is formed into particles that are finer than those of the carrier, typically around 30 nm or less, but preferably even smaller than this; down to 0.1 nm or less, preferably around 0.05 nm or 50 pm, which is similar in size to the spacing between atoms in a hydrogen molecule. The dopant will therefore be described herein as a fine or superfine powder.

The method of forming the dopant particles will vary dependent on the material that is used for the dopant. In many embodiments, for example where a ceramic or metallic dopant is used, the dopant can be ground into the fine powder. For other materials, in particular for forms of carbon, nanoparticles can be grown to form a superfine dopant powder.

Once formed, the powdered dopant material is coated with a primer, typically by adding a drop of a liquid primer to the powdered dopant material and allowing it to wick into the dopant material, wet it and coat it. The primer helps the dopant adhere and bond to the carrier, in particular by increasing the surface energy of the dopant. The primer can also promote linking between the dopant and the carrier material, by providing an intermediate layer to which both the dopant and the carrier will adhere.

In more detail, the primer is a surface modifier that increases the opportunity for bonding to occur between the carrier and the dopant when the dopant is mixed into the carrier material. In particular, as described in more detail below, the primer may act alone or in combination with an energy source to increase the surface energy of the materials to which it is applied.

Materials such as the polymers that are used for the carrier material have a low surface energy. The electrons at the surface of these materials are bonded into the molecules and are in low energy states, which means that they do not readily interact to form bonds with adjacent molecules of other materials, in this case the dopant. In order to promote bonding between the carrier and the dopant, it is helpful to increase the surface energy of the polymeric carrier. Further, increasing the surface energy of the carrier can promote a thinner and more even spread of the primer-coated dopant across the surface of the carrier material. In particular, spreading of the primer-coated dopant across the surface of the carrier is promoted if the surface energy of the carrier is higher than that of the primer-coated dopant.

In some cases, depending on the materials being used for the carrier and the dopant, application of energy during the process of mixing the dopant with the carrier may be sufficient to promote bonding between the carrier and the dopant in the presence of a primer. Typically, the primer that coats the dopant material acts to increase the surface energy of the carrier material by linking to the carrier material to provide a hook to which the particles of the dopant can connect and cross-link. Many different types of bonds may be formed between the primer and each of the carrier and the dopant or, to some extent, directly between the dopant and the carrier. Most commonly, chemical bonds can be formed, particularly with the application of electromagnetic energy (heat/infrared energy, ultraviolet energy or broad-spectrum electromagnetic radiation for example from the sun) or sound energy (such as ultrasound), or in the presence of a reagent such as ozone.

Mechanical bonds that are based on the geometries within the particles may also be formed. Other types of bonds include those based on London dispersion forces. Van der Waals forces, molecular bonds and molecular cross-linking bonds.

Suitable primers include any substance that operates in this way to raise surface energy and promote cross-linking for the particular carrier material or dopant/carrier combination. In particular, a vinyl-based primer or a solvent such as a methylene would be suitable to act as a surface adhesion promoter, particularly one that is “thin” and can therefore coat the dopant and adhere to the carrier at a high resolution.

A better coverage of primer means that the dopant more comprehensively and evenly adheres to the carrier, thus promoting a more even cross-linking between the carrier and dopant. An even distribution of dopant throughout the carrier helps to produce a more homogeneous resultant material, which reduces the chance of the ultrasound wave being internally refracted. Each portion of doped carrier material is then formed by taking a set amount of the carrier glue and a net amount by weight of the carrier pellets and dopant powder. Typically, the composite or portion comprises around 50% by weight glue and 50% by weight of pellets and powder. However, different amounts of dopant powder are added to the different portions of material to form composites with different acoustic impedances. However, the viscosity of each portion should be the same so that it reacts the same way physically during the manufacturing process and with the incoming ultrasound waves. Thus, the ratio of the carrier pellets 42 to the dopant powder 44 being added to the carrier/primer mix is different for each of the portions of material used for each composite, but the total amount of carrier and dopant by weight that is added to each portion of material is kept constant.

For instance, in an illustrative embodiment as is shown in FIG. 4, ten parts by weight of carrier and dopant may be added in total to the carrier glue 40.I In reality, the amount of carrier and dopant added to the carrier will be higher and closer to 50% by weight of the finished composite. It is further noted that, although the dopant powder is illustrated as beads with the same diameter as the carrier pellets, this is for illustrative purposes only in order to indicate schematically the relative amounts of dopant and carrier and, in reality, the dopant will be in the form of a powder with a much lower particle size than that of the carrier.

To make a portion of doped carrier which will form the composite with the lowest acoustic impedance (ix), just one part by weight of the dopant 42 will be added with nine parts by weight of the carrier 44. To make a portion of doped carrier which will form the composite with the highest acoustic impedance (i), nine parts by weight of the dopant will be added and just one part by weight of the carrier. The portions of doped carrier to form the composites in between, (ii) to (viii), will have different proportions of dopant and carrier. In this way, the carrier, or silicone, pellets fill in the slack in the ratio to maintain constant physical properties across the matching layer. Keeping constant the total amount by weight of carrier and dopant added to the carrier glue when making each portion of doped carrier material, ensures that the malleability or viscosity of the successive composites is kept substantially constant. This is important since a change in malleability between the resulting composites can lead to shear forces within the material as the sound wave passes through, causing some of the ultrasound energy to be converted to heat via friction i.e. attenuation of the ultrasound energy.

If an undoped composite matches the impedance of the target sufficiently closely without the use of any dopant, then the first composite comprises ten parts by weight of carrier, without any dopant.

The carrier and dopant that have been added into the carrier glue are then mixed in. At this stage, the mixer contains doped carrier material of the correct acoustic impedance, when subsequently thoroughly mixed and/or cured, to form a composite of the resulting matching layer. The doped carrier material can be stored at this stage and the further steps carried out at a later stage, or the further steps can be immediately carried out.

In order to promote the cross-linking throughout the composite, to cure the mix, a catalyst needs to be added into the mix. For an inorganic material, a catalyst such as tin, peroxide or platinum would be suitable. For an organic material, the vulcanization process may be catalysed by substances such as sulphur and zinc oxide. The composite is cured by mixing the catalyst in with the dopant/carrier mix. When the catalyst has been added and the mix cured, the properties of the mix are tested and checked to ensure that they meet the expected pre-determined acoustic impedance criterion for use in making a particular composite.

Due to London Dispersion effects and/or Van der Waal forces in the material, which can cause the particles in the mixture to repel, straightforward mixing of the dopant and carrier does not provide sufficient mixing of the components.

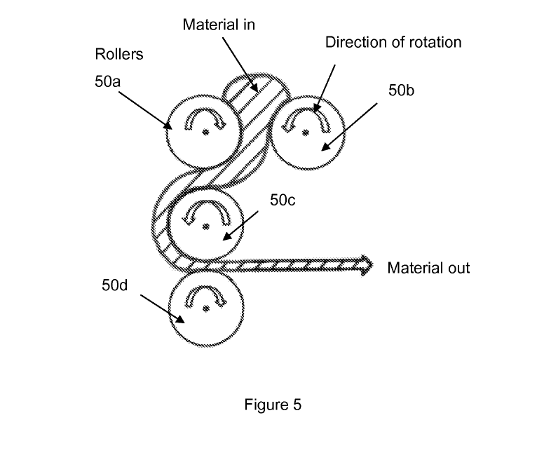

In order to promote mixing, the material is fed through a calender process, as is shown in FIG. 5, although a greater or fewer number of rollers can be used. The calender consists of a series of hard pressure rollers, the rollers gradually applying increased levels of pressure to the material as the material passes through the calender. With reference to FIG. 5, rollers 50a and 50b have a larger spacing than rollers 50a and 50c, which in turn have a larger spacing than rollers 50c and 50d.

To ensure the dopant and carrier are properly mixed, the resultant portion is laid flat and then rolled up across its width so that the portion has a spiral cross section, or double-spiral cross section in which each of the edges is rolled towards the centre. These steps of putting the portion of material through the calender and re-rolling the material, is repeated until the carrier and dopant are sufficiently mixed and considered “ready”. To overcome the effects of the London Dispersion and/or Van der Waals, the process of folding and calendering can be repeated on each doped portion 100s or 1000s of times. In particular, the skilled person will appreciate that rolling the calendered composite, as described above, between each calendering process creates a large number of layers within the composite mixture and this lamination mixes particles at the edges of the material into the middle and centre of the composite before the material is further calendered.

This repeated process of lamination ensures a very efficient mixing and increases the probability of dispersion of dopant within the material to ensure that the resulting material is homogeneous at a sub-nanometre resolution. The lamination and re-rolling being repeated many times for each layer, also facilitates the removal of air bubbles from the layer. After processing, any remaining air bubbles in the layer would be smaller in diameter than λ/10 and would therefore be invisible to the ultrasound wave. In one method of manufacturing the matching layer, the mixed and rolled material for forming the composite can then be kept like this, ready to use, for as long as necessary until it is to be used within a matching layer. Alternatively, all of the above could have been performed without the catalyst and the catalyst could be added at this stage, or at a later stage to cure the dopant/carrier mix.

Typically, the portion of the now cured dopant/carrier mix is extruded into a length of the mix that is approximately 0.5-1 mm thick, 1-2 cm wide and several metres long. Each composite can be formed according to the above method, and be rolled into a spiral, like a roll of tape, or otherwise kept, until all the composites are formed and ready to be incorporated into a matching layer. In order to prevent the composites from sticking together as they are piled up, a non-stick layer of material can be put between the composites, typically comprising polypropylene, perfluoroalkoxy alkanes (PFA) or melamine.

If the formed composites are stored for later use, before they are used to make the matching layer, they may be again calendered and rolled repeatedly, for example to mix in a catalyst to cure the material if this has not already been done, until they are again considered sufficiently mixed for use in the matching layer.

This second pass of mixing and rolling also ensures that the composite is sufficiently even in thickness and surface profile to ensure a uniform matching layer.

Once the portions of material for each composite are formed and are ready to be incorporated into a matching layer, the composites, comprising differently doped material are stacked up into a pile so that the acoustic impedance of each portion gradually decreases between successive portions, as will be the case for the resultant internal layers in the matching layer. Pressure is than applied to the pile using rollers in a calendering process similar to that described above, to get the pile to the right thickness and to squeeze out any remaining air bubbles. Applying pressure, and specifically rolling the stratified layers out, helps to fix and cross-link the dopant to the polymer, providing a chemical bond between the silicone rubber and the dopant. Cross-links may also be formed between dopant at the edge of one composite and carrier material at the edge of the next composite, so there is no clear boundary between composites of different acoustic impedance.

The pile is then calendered, setting the rollers to the require thickness to end up with a finished matching layer of specific thickness. The resultant product is an impedance matching layer of desired thickness, with a gradual decrease in acoustic impedance across the layers from one side having an acoustic impedance which substantially matches that of the crystal, to the other side substantially matching that of the tissue. This process provides an extremely high consistency in the thickness of each composite, the accuracy of each layer being on the Angstrom (1×10⁻¹⁰ m) level.

It is noted that no adhesive layer is required between the composite sub-layers. Further, it is noted that each of the composites is manufactured using essentially the same materials in different, and controlled proportions.

In use, the ultrasound probe is applied to a part of the body to be scanned. The power supply and leads are used to apply a voltage across the piezoelectric crystal within the probe. The voltage across the crystal is switched rapidly at a particular frequency, which causes the crystal to vibrate at a corresponding resonant frequency and produce ultrasound waves with a corresponding frequency. The frequency will be in the range of 1-500 MHz. Any backwardly directed ultrasound waves are absorbed by the backing block. The ultrasound generated and directed towards the tissue to be scanned passes through the adjacent matching layer. In one particular example, the piezoelectric crystal has an acoustic impedance of 30 MRayls and the tissue to be scanned has an acoustic impedance of 1.5 MRayls. The impedance matching layer is thus manufactured according to the above described method, the first composite within the matching layer having an acoustic impedance of approximately 30 MRayls to substantially match that of the crystal, and the final composite within the matching layer having an acoustic impedance of approximately 1.5 MRayls to substantially match that of the tissue to be scanned. Therefore, the ultrasound passing through the matching layer does not see any boundary between the piezoelectric crystal and the matching layer, or between the matching layer and the tissue to be scanned, so there is minimal reflection and/or attenuation of the ultrasound at these points.

The other composites within the matching layer are manufactured such that they gradually reduce in impedance across the matching layer, and the difference in acoustic impedance between adjacent composites is minimal such that the difference between the composites is negligible to the ultrasound wave. Effectively, the difference is so small that it could just as easily be a discrepancy or inhomogeneity within a substantially pure material. Therefore, the ultrasound wave does not see any boundaries between all of the other layers but just experiences a gradual reduction in acoustic impedance, freely passing through the matching layer and into the tissue to be scanned, with a significant proportion of the ultrasound energy being transmitted through the matching layer.

The ultrasound waves are then reflected of the tissue to form echoes and these echoes then pass back through the matching layer to the crystal. The echoes cause the crystal to vibrate at a corresponding frequency and these vibrations are processed externally from the ultrasound probe to generate images of the internal structure of the tissue, using information such as the frequency, strength and time it takes for the echoes to return. Clearly, the presence of the impedance matching layer is equally important in enabling a high proportion of the ultrasound energy to pass out of the target that is being scanned back towards the receiver.

The above embodiments are described by way of example only. Many variations are possible without departing from the scope of the invention as defined in the appended claims.

1. A matching layer for facilitating the transmission of ultrasound energy between an ultrasound source and a target, the matching layer having an acoustic impedance that decreases across the matching layer, wherein the matching layer comprises at least 10 adjacent composites, each composite comprising a carrier material and each composite having an acoustic impedance lower than that of the adjacent composite, and wherein a plurality of the composites further comprise a dopant.

2. The matching layer according to claim 1 wherein each composite comprises a dopant.

3. (canceled)

4. The matching layer according to claim 1 wherein each composite comprises the same carrier material.

5. The matching layer according to claim 1 wherein the carrier material comprises a polymeric carrier material.

6. The matching layer according to claim 1 wherein the dopant is mixed with the carrier to form substantially homogeneous composites.

7. The matching layer according to claim 1 wherein the proportion of dopant to carrier in each of the composites varies between composites to vary the acoustic impedance of each composite.

8. (canceled)

9. The matching layer according to claim 1 further comprising a primer for increasing the surface energy of the carrier.

10. (canceled)

11. (canceled)

12. The matching layer according to claim 1 wherein the matching layer comprises at least 20 layers.

13. (canceled)

14. The matching layer according to claim 1 wherein the thickness of the matching layer is less than 5 mm.

15. (canceled)

16. (canceled)

17. The matching layer according to claim 1 wherein the acoustic impedance decreases substantially linearly across the matching layer.

18. The matching layer according to claim 1 wherein the composites are superimposed directly without an adhesive layer.

19. The matching layer according to claim 1 wherein the malleability of each composite is substantially constant.

20. (canceled)

21. (canceled)

22. (canceled)

23. (canceled)

24. (canceled)

25. The matching layer according to claim 1 wherein the carrier comprises a curable polymer

26. The matching layer according to claim 1 wherein the carrier comprises a chemical cure polymer.

27. The matching layer according to claim 1 wherein the carrier comprises a thermoset polymer, preferably wherein the polymer comprises at least one of: a polypropylene, acrylonitrile butadiene styrene (ABS), polyethylene, Bakelite, a HVAC silicone and/or a high-consistency rubber.

28. The matching layer according to claim 1 wherein the carrier comprises polyvinylidene fluoride (PVDF).

29. (canceled)

30. (canceled)

31. The matching layer according claim 1 wherein the dopant comprises a metal, carbon or a ceramic.

32. (canceled)

33. (canceled)

34. The matching layer according claim 1 wherein the dopant comprises a metallic or transition metal carbide, oxide, sulphide or nitride.

35. (canceled)

36. (canceled)

37. (canceled)

38. (canceled)

39. (canceled)

40. A method of manufacturing a material to form a composite for an ultrasound matching layer, the method comprising:
providing a starter for the composite, the starter comprising a carrier material;
providing a plurality of pellets of the carrier material;
providing particles of a dopant material, wherein the particles of the dopant material are smaller than the pellets of the carrier material;
adding to the starter a predetermined weight of the dopant material to form a composite having a selected acoustic impedance;
adding to the starter a complementary weight of pellets of the carrier material such that the total weight of dopant and carrier added to the starter remains the same regardless of the selected acoustic impedance.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. A method of manufacturing an impedance matching layer for an ultrasound apparatus, the method comprising:
providing a plurality of composites, each composite having a different acoustic impedance;
arranging the composites in a stack in decreasing order of acoustic impedance; calendering the stack of composites to reduce the thickness of the stack.

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)
